(19) United States
(12) Patent Application Publication
(10) Pub. No.: US 2013/0096224 A1
(43) Pub. Date: Apr. 18, 2013

(54) POLYURETHANE BASED PHOTOINITIATORS

(71) Applicants: Christian B. Nielsen, Copenhagen NV (DK); Niels Joergen Madsen, Alleroed (DK)

(72) Inventors: Christian B. Nielsen, Copenhagen NV (DK); Niels Joergen Madsen, Alleroed (DK)

(21) Appl. No.: 13/805,076

(22) PCT Filed: Jun. 22, 2011
(86) PCT No.: PCT/DK2011/050225

§ 371 Date: Dec. 18, 2012

(30) Foreign Application Priority Data
Jun. 22, 2010 (DK) PA201070282
Jul. 27, 2010 (DK) PA201070342
Dec. 22, 2010 (DK) PA201070572
Jun. 16, 2011 (DK) PA201170305

(51) Int. Cl. C08G 18/76; C08J 3/28

(52) U.S. Cl. CPC C08G 18/7614; C08J 3/28
USPC 522/162; 528/79

(57) ABSTRACT

A photoinitiator of the general formula (I): (—(R₁(A₁)ₘ)ᵤ—(R₂(A₂)ₙ-0)₀—(R3(A₃)ₚ-0)_{q-(R4(A}₄)ᵣ)ᵥ-C(0)NH—R₅(A₅)₅-NHC(0))ₜ- wherein R₁(R₂, R₃, R₄ and R₅ and m, n, o, p, q, r, s, t, u and v are as defined herein and A₁, A₂, A₃, A₄ and A₅ are identical or different photoinitiator moieties.

### FIELD OF THE INVENTION

The present invention relates to novel polymeric photoinitiators based on polyalkyletherurethane backbones. Photoinitiator moieties are pendant on the polymeric backbone.

### BACKGROUND OF THE INVENTION

Curing of coatings through ultraviolet (UV) radiation, thereby resulting in a coating for use as a gel (e.g. a hydrogel), requires efficient methods of initiating the chemical reaction responsible for the curing process. Cross-linking of polymeric material through generation of radical species upon irradiation with UV light is widely used to produce hydrogels for medical device coatings. Coating compositions with polyvinylpyrrolidone and a photoinitiator as the main constituents, which are cured with UV irradiation, are often used for producing hydrogels. The photoinitiators used in these processes can be either oligomeric or polymeric. Oligomeric photoinitiators are partially free to diffuse to the surface of the cured material, thereby rendering these substances exposed to the environment.

Polymeric photoinitiators are disclosed in EP 0 849 300, WO 2008/012325 and Wei et al. Polymers for Advanced Technologies, 2008, vol. 18, no. 12, p. 1763-1770.

### OBJECT OF THE INVENTION

The object of the present invention is to provide polymeric photoinitiators, as well as to provide means and methods for the UV curing of these photoinitiators.

### SUMMARY OF THE INVENTION

One aspect of the present invention is to provide polymeric photoinitiators with the general motif shown in FIG. 1, and in particular systems derived from polyalkylethers carrying photoinitiator moieties pendant from the isocyanate moiety.

So, in a broad aspect, the present invention relates to a polymeric photoinitiator of the general formula I:

(—(R₁(A₁)ₘ)ᵤ-(R₂(A₂)ₙ-O)ₒ—(R₃(A₃)ₚ-O)_{q}-(R₄(A₄)ᵣ)ᵥ-C(O)NH—R₅(A₅)₅-NHC(O))ₜ— (I)

In the above formula (I), R₂, R₃ and R₅ can each independently be selected from C1-C25 linear alkyl, C3-C25 branched alkyl, C3-C25 cycloalkyl, aryl and heteroaryl groups such as any aromatic hydrocarbon with up to 20 carbon atoms;

R₁ and R₄ are each independently selected from C1-C25 linear alkyl, C3-C25 branched alkyl, C3-C25 cycloalkyl, aryl, heteroaryl, hydrogen, —OH, —CN, halogens, amines (e.g. —NR′R″, where R′ and R″ are alkyl groups, suitably C1-C25 alkyl groups), amides (e.g. —CONR′R″ or R′CONR″—, where R′ and R″ are alkyl groups, suitably C1-C25 alkyl groups), alcohols, ethers, thioethers, sulfones and derivatives thereof, sulfonic acid and derivatives thereof, sulfoxides and derivatives thereof, carbonates, nitrates, acrylates, hydrazine, azines, hydrazides, polyethylenes, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides (e.g. —CONR′R″ or R′CONR″—, where R′ and R″ are alkyl groups, suitably C1-C25 alkyl groups); halogen atoms; sulfones; sulfonic derivatives; NH₂ or Nalk₂, where alk is any C₁-C₈ straight chain alkyl group, C₃-C₈ branched or cyclic alkyl group;

m, n, p, and r are independently real numbers from 0 to 10 and s is a real number greater than or equal to 1;

o and q are independently real numbers from 0 to 10000, provided that both o and q are not zero;

u and v are independently real numbers from 0 to 1;

t is an integer from 1 to 10000; and

A₁, A₂, A₃, A₄ and A₅ are identical or different photoinitiator moieties.

Further details of the polymeric photoinitiators of the invention are set out in the dependent claims.

The invention also provides a method for the manufacture of a cross-linked matrix composition, said method comprising the steps of
a. providing a matrix composition consisting of a polymeric photoinitiator of the general formula I:

(—(R₁(A₁)ₘ)ᵤ-(R₂(A₂)ₙ)-O)ₒ—(R₃(A₃)ₚ-O)_{q}—(R₄(A₄)ᵣ)ᵥ-C(O)NR—R₅(A₅)ₛ-NHC(O))ₜ— (I)
wherein R₂, R₃ and R₅ can each independently be selected from C1-C25 linear alkyl, C3-C25 branched alkyl, C3-C25 cycloalkyl, aryl and heteroaryl groups such as any aromatic hydrocarbon with up to 20 carbon atoms;
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, hydrazine, azines, hydrazides, polyethylenes, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁C₈ straight chain alkyl group, C₃-C₈ branched or cyclic alkyl group;
m, n, p, r and s are real numbers, from 0 to 10, provided that the sum of n+p+s is a real number greater than 0;
o and q are real numbers from 0 to 10000;
u and v are real numbers from 0 to 1;
t is an integer from 1 to 10000; and
A₁, A₂, A₃, A₄ and A₅ are identical or different photoinitiator moieties, and
b. curing the matrix composition obtained in step a. by exposing it to UV radiation.

The invention relates to cross-linked matrix composition obtainable via this method. The invention also provides the use of a polymeric photoinitiator according to the invention for curing a matrix composition.

### LEGENDS TO THE FIGURE

FIG. 1 illustrates a general motif of polymeric photoinitiators, with photoinitiator moieties pendant on a polymeric backbone.

FIG. 2 illustrates curing of a matrix composition which is followed by monitoring the change of G′ and G″ measured at 1 Hz as a function of UV exposure time.

### DETAILED DISCLOSURE OF THE INVENTION

The present invention provides polymeric photoinitiators based on polyurethanes.

The invention thus provides photoinitiator of the general formula I:

(—(R₁(A₁)ₘ)ᵤ-(R₂(A₂)ₙ-O)ₒ—(R₃(A₃)ₚ-O)_{q}-(R₄(A₄)ᵣ)ᵥ-C(O)NH—R₅(A₅)ₛ-NHC(O))ₜ— (I)

R₂, R₃ and R₅ can each independently be selected from C1-C25 linear alkyl, C3-C25 branched alkyl, C3-C25 cycloalkyl, aryl and heteroaryl groups such as any aromatic hydrocarbon with up to 20 carbon atoms. Suitably, R₂ and R₃ are each independently selected from C1-C25 linear alkyl, C3-C25 branched alkyl and C3-C25 cycloalkyl, preferably C1-C25 linear alkyl. R₅ may be selected from the group consisting of C3-C25 cycloalkyl and aryl groups.

R₁ and R₄ are each independently selected from C1-C25 linear alkyl, C3-C25 branched alkyl, C3-C25 cycloalkyl, aryl, heteroaryl, hydrogen, —OH, —CN, halogens, amines (e.g. —NR′R″, where R′ and R″ are alkyl groups, suitably C1-C25 alkyl groups), amides (e.g. —CONR′R″ or R′CONR″—, where R′ and R″ are alkyl groups, suitably C1-C25 alkyl groups), alcohols, ethers, thioethers, sulfones and derivatives thereof, sulfonic acid and derivatives thereof, sulfoxides and derivatives thereof, carbonates, isocyanates, nitrates, acrylates, hydrazine, azines, hydrazides, polyethylenes, polypropylenes, polyesters, polyamides, polyacrylates, polystyrenes, and polyurethanes. R₁ and R₄ may each independently be selected from C1-C25 linear alkyl, C3-C25 branched alkyl and C3-C25 cycloalkyl.

R₁ and R₄ may be end-functionalized with alcohol, ether, urethane or amine groups, alternatively other nucleophilic groups, in either one or both ends. Alternatively, R₁ and R₄ can be considered as originating from chain extenders, where suitable extenders can include ethylene diamine, diethylene triamine, triethylene tetramine, propylene diamine, butylenes diamine, hexamethylene diamine, cyclohexylene diamine, piperazine, 2-methyl-piperazine, phenylene diamine, tolylene diamine, xylylene diamine, tris(2-aminoethyl) amine, 3,3′-dinitrobenzidine, 4,4′-methylenebis (2-chloroaniline), 3,3′-dichloro-4,4′-bi-phenyl diamine, 2,6-diaminopyridine, 4,4′-diaminodiphenylmethane, menthane diamine, m-xylene diamine and isophorone diamine.

R₁ and R₄ may also be selected from the group consisting of hydrazine; azines such as acetone azine; substituted hydrazines such as dimethyl hydrazine, 1,6-hexamethylene-bishydrazine, and carbodihydrazine; hydrazides of dicarboxylic acids and sulfonic acids such as adipic acid mono- or dihydrazide, oxalic acid dihydrazide, isophthalic acid dihydrazide, tartaric acid dihydrazide, 1,3-phenylene disulfonic acid dihydrazide, omega-amino-caproic acid dihydrazide; hydrazides made by reacting lactones with hydrazine such as gamma-hydroxylbutyric hydrazide, bis-semi-carbazide; bis-hydrazide carbonic esters of glycols such as any of the glycols mentioned above.

When R₁ and R₄ are alkyl and aryl groups, they may be substituted with one or more substituents selected from CN; OH; azides; esters; ethers; amides (e.g. —CONR′R″ or R′CONR″—, where R′ and R″ are alkyl groups, suitably C1-C25 alkyl groups); halogen atoms; sulfones; sulfonic derivatives; NH₂ or Nalk₂, where alk is any C₁-C₈ straight chain alkyl group, C₃-C₈ branched or cyclic alkyl group.

In the polymeric photoinitiators of Formula (I), m, n, p, and r are independently real numbers from 0 to 10 and s is a real number greater than or equal to 1 (i.e. A₅ is always present). In other words, the polymeric photoinitiators of Formula (I) are those in which all isocyanate groups (R₅) comprise photoinitiators (i.e. there are no isocyanate groups present in the polymer which do not comprise photoinitiators). By incorporating the photoinitiator moiety into the isocyanate groups (R₅), matrix compositions comprising may be provided which comprise fewer components.

In the polymeric photoinitiators of Formula (I), o and q are real numbers from 0 to 10000, provided that both o and q are not zero.

Suitably, o and q are real numbers from 0-5000, preferably 100-2000.

In the polymeric photoinitiators of Formula (I), u and v are independently real numbers from 0 to 1. Preferably u and v are independently real numbers greater than zero.

In the polymeric photoinitiators of Formula (I), t is an integer from 1 to 10000. Suitably, t is an integer from 1 to 5000, preferably 100-2000.

In one embodiment, s is greater than or equal to 1 meaning that at least one photoinitiator group is always present on the isocyanate precursor. Alternatively or additionally, p may be greater than or equal to 1, thus there is at least one photoinitiator moiety per repeating unit of one of the alkylether segments. This allows extra flexibility in the number and type of photoinitiator moieties present, including the possibility of two complementary photoinitiator moieties. n may also be greater than or equal to 1, which also results in at least one photoinitiator moiety per repeating unit of one of the alkylether segments. Alternatively or additionally, r and v are greater than or equal to 1, where r is the number of photoinitiators on the R₄ segment and v is the number of R₄(A₄)ᵣ segments per repeating unit of the polyurethane chain r may be zero, as may m. Similar to r, m is the number of photoinitiators on the R₁ segment. p and q may be greater than or equal to 1.

It may be possible that the sum m+n+p+r+s is 1.

The indices o, m, n, o, p, q, r, s, v and u in the general formula (I) represent an average/sum and the formula (I) thereby represents alternating, periodic, statistical/random, block and grafted copolymers. An example of a random copolymer may be the copolymer ABAAABABAABABAA having the formula (A₂13₁)₅ by applying a nomenclature similar to formula I.

An example of the identity of formula I applied to a polymeric photoinitiator described in the present invention is given in Scheme 1.

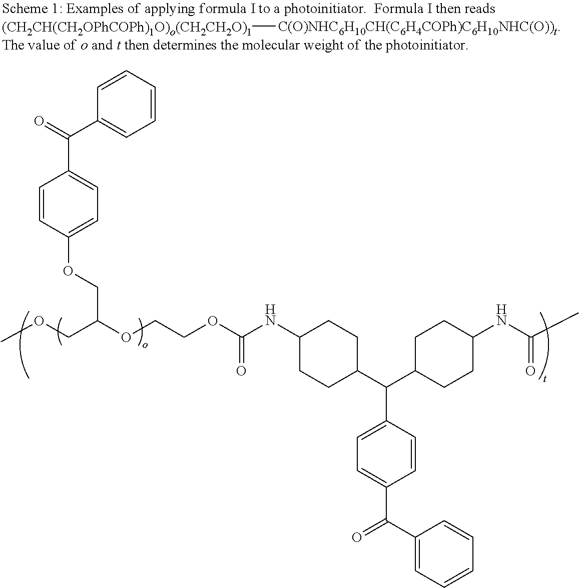

Photoinitiator and Photoinitiator Moieties

In the polymeric photoinitiators of Formula (I), A₁, A₂, A₃, A₄ and A₅ are identical or different photoinitiator moieties.

In the present invention, a photoinitiator is defined as a moiety which, on absorption of light, generates reactive species (ions or radicals) and initiates one or several chemical reactions or transformation. One preferred property of the photoinitiator is good overlap between the UV light source spectrum and the photoinitiator absorption spectrum. Another desired property is a minor or no overlap between the photoinitiator absorption spectrum and the intrinsic combined absorption spectrum of the other components in the matrix composition.

Suitably, the photoinitiator moieties are pendant on the polymer. This means that they are attached to the polymer at points other than at the polymer ends.

The photoinitiator moieties of the invention may independently be cleavable (Norrish Type I) or non-cleavable (Norrish Type II). Upon excitation, cleavable photoinitiator moieties spontaneously break down into two radicals, at least one of which is reactive enough to abstract a hydrogen atom from most substrates. Benzoin ethers (including benzil dialkyl ketals), phenyl hydroxyalkyl ketones and phenyl aminoalkyl ketones are important examples of cleavable photoinitiator moieties. The photoinitiator moieties of the invention are efficient in transforming light from the UV or visible light source to reactive radicals which can abstract hydrogen atoms and other labile atoms from polymers, and hence effect covalent cross-linking. Optionally, amines, thiols and other electron donors can be either covalently linked to the polymeric photoinitiator or added separately or both. The addition of electron donors is not required but may enhance the overall efficiency of cleavable photoinitiators according to a mechanism similar to that described for the non-cleavable photoinitiators below.

Suitably, the photoinitiator moieties of the invention are all non-cleavable (Norrish Type II). For reference, see e.g. A. Gilbert, J. Baggott: “Essentials of Molecular Photochemistry”, Blackwell, London, 1991). Non-cleavable photoinitiator moieties do not break down upon excitation, thus providing fewer possibilities for the leaching of small molecules from the matrix composition. Excited non-cleavable photoinitiators do not break down to radicals upon excitation, but abstract a hydrogen atom from an organic molecule or, more efficiently, abstract an electron from an electron donor (such as an amine or a thiol). The electron transfer produces a radical anion on the photoinitiator and a radical cation on the electron donor. This is followed by proton transfer from the radical cation to the radical anion to produce two uncharged radicals; of these the radical on the electron donor is sufficiently reactive to abstract a hydrogen atom from most substrates. Benzophenones and related ketones such as thioxanthones, xanthones, anthraquinones, fluorenones, dibenzosuberones, benzils, and phenyl ketocoumarins are important examples of non-cleavable photoinitiators. Most amines with a C—H bond in α-position to the nitrogen atom and many thiols will work as electron donors. The photoinitiator moieties of the invention are preferably non-cleavable. The advantage of using Type II as opposed to Type I photoinitiators is fewer generated by-products during photoinitiated reactions. As such benzophenones are widely used. When for example α-hydroxy-alkyl-phenones dissociate in a photoinitiated reaction, two radicals are formed, which can further dissociate and possibly form loosely bound unwanted aromatic by-products.

Self-initiating photoinitiator moieties are within the scope of the present invention. Upon UV or visible light excitation, such photoinitiators predominantly cleave by a Norrish type I mechanism and cross-link further without any conventional photoinitiator present, allowing thick layers to be cured. Recently, a new class of β-keto ester based photoinitiators has been introduced by M. L Gould, S. Narayan-Sarathy, T. E. Hammond, and R. B. Fechter from Ashland Specialty Chemical, USA (2005): “Novel Self-Initiating UV-Curable Resins: Generation Three”, Proceedings from RadTech Europe 05, Barcelona, Spain, Oct. 18-20 2005, vol. 1, p. 245-251, Vincentz. After base-catalyzed Michael addition of the ester to polyfunctional acrylates, a network is formed with a number of quaternary carbon atoms, each with two neighbouring carbonyl groups.

Another self-initiating system based on maleimides has also been identified by C. K. Nguyen, W. Kuang, and C. A. Brady from Albemarle Corporation and Brady Associates LLC, both USA (2003): “Maleimide Reactive Oligomers”, Proceedings from RadTech Europe 03, Berlin, Germany, Nov. 3-5, 2003, vol. 1, p. 589-94, Vincentz. Maleimides initiate radical polymerization mainly by acting as non-cleavable photoinitiators and at the same time spontaneously polymerize by radical addition across the maleimide double bond. In addition, the strong UV absorption of the maleimide disappears in the polymer, i.e. maleimide is a photobleaching photoinitiator; this could make it possible to cure thick layers.

So, in an embodiment of the invention, the photoinitiator moieties include at least two different types of photoinitiator moieties. Preferably, the absorbance peaks of the different photoinitiators are at different wavelengths, so the total amount of light absorbed by the system increases. The different photoinitiators may be all cleavable, all non-cleavable, or a mixture of cleavable and non-cleavable. A blend of several photoinitiator moieties may exhibit synergistic properties, as is e.g. described by J. P. Fouassier: “Excited-State Reactivity in Radical Polymerization Photoinitiators”, Ch. 1, pp. 1-61, in “Radiation curing in Polymer Science and technology”, Vol. II (“Photo-initiating Systems”), ed. by J. P. Fouassier and J. F. Rabek, Elsevier, London, 1993. Briefly, efficient energy transfer or electron transfer takes place from one photoinitiator moiety to the other in the pairs [4,4′-bis(dimethyl-amino)benzophenone+benzophenone], [benzophenone+2,4,6-trimethylbenzophenone], [thioxanthone+methylthiophenyl morpholinoalkyl ketone].

Furthermore, it has recently been found that covalently linked 2-hydroxy-1-(4-(2-hydroxyethoxy)phenyl)-2-methylpropan-1-one, which is commercially available with the trade name Irgacure 2959, and benzophenone in the molecule 4-(4-benzoylphenoxyethoxy)phenyl 2-hydroxy-2-propyl ketone gives considerably higher initiation efficiency of radical polymerization than a simple mixture of the two separate compounds, see S. Kopeinig and R. Liska from Vienna University of Technology, Austria (2005): “Further Covalently Bonded Photoinitiators”, Proceedings from RadTech Europe 05, Barcelona, Spain, Oct. 18-20 2005, vol. 2, p. 375-81, Vincentz. This shows that different photoinitiator moieties may show significant synergistic effects when they are present in the same oligomer or polymer.

Each and every one of the above-discussed types of photoinitiators and photoinitiator moieties may be utilised as photoinitiator moieties in the polymeric photoinitiators of the present invention.

In an embodiment of the polyalkyletherurethane-derived photoinitiator according to the invention, A₁, A₂, A₃, A₄ and A₅, identical or different photoinitiator moieties, are selected from the group consisting of benzoin ethers, phenyl hydroxyalkyl ketones, phenyl aminoalkyl ketones, benzophenones, thioxanthones, xanthones, acridones, anthraquinones, fluorenones, dibenzosuberones, benzils, benzil ketals, α-dialkoxy-acetophenones, α-hydroxy-alkyl-phenones, α-amino-alkyl-phenones, acyl-phosphine oxides, phenyl ketocoumarins, silane, maleimides, and derivatives thereof. The group can also consist of derivatives of the photoinitiator moieties listed.

Suitably, A₁, A₂, A₃, A₄ and A₅ are selected from the group consisting of benzoin ethers, phenyl hydroxyalkyl ketones, phenyl aminoalkyl ketones, benzophenones, thioxanthones, xanthones and derivatives thereof. The group can also consist of derivatives of the photoinitiator moieties listed.

Typically, at least one of A₁, A₂, A₃, A₄ and A₅ is an optionally-substituted benzophenone moiety. By “optionally substituted” in the present context is meant that the benzophenone moiety is substituted with one or more R₁ groups.

### Polymeric Photoinitiators of the Invention

### Polyurethane Derived Photoinitiators

The polyurethane based photoinitiators can be synthesized by reacting a polyalkyloxide based photoinitiator with a diisocyanate optionally using a catalyst such as a tin salt, an organic tin ester, for example, dibutyltin dilaurate or a tertiary amine such as triethyl diamine, N,N,N′,N′-tetramethyl-1,3-butane diamine or other recognized catalysts for urethane reactions known in the art. Further examples are stannous octoate, triethylamine, (dimethylaminoethyl) ether, morpholine compounds such as β,β′-dimorpholinodiethyl ether, bismuth carboxylates, zinc bismuth carboxylates (e.g. BICAT catalysts from Shephard chemicals), iron(III) chloride, potassium octoate, potassium acetate, and DABCO (diazabicyclo[2.2.2]octane), and also a mixture of 2-ethylhexanoic acid and stannous octoate. The mentioned catalysts may also be used in combination with each other and typically in the amounts of 5 to 200 parts per million of the total weight of prepolymer reactants. An exemplified method for synthesizing polyurethane based photoinitiators is depicted in Scheme 2.

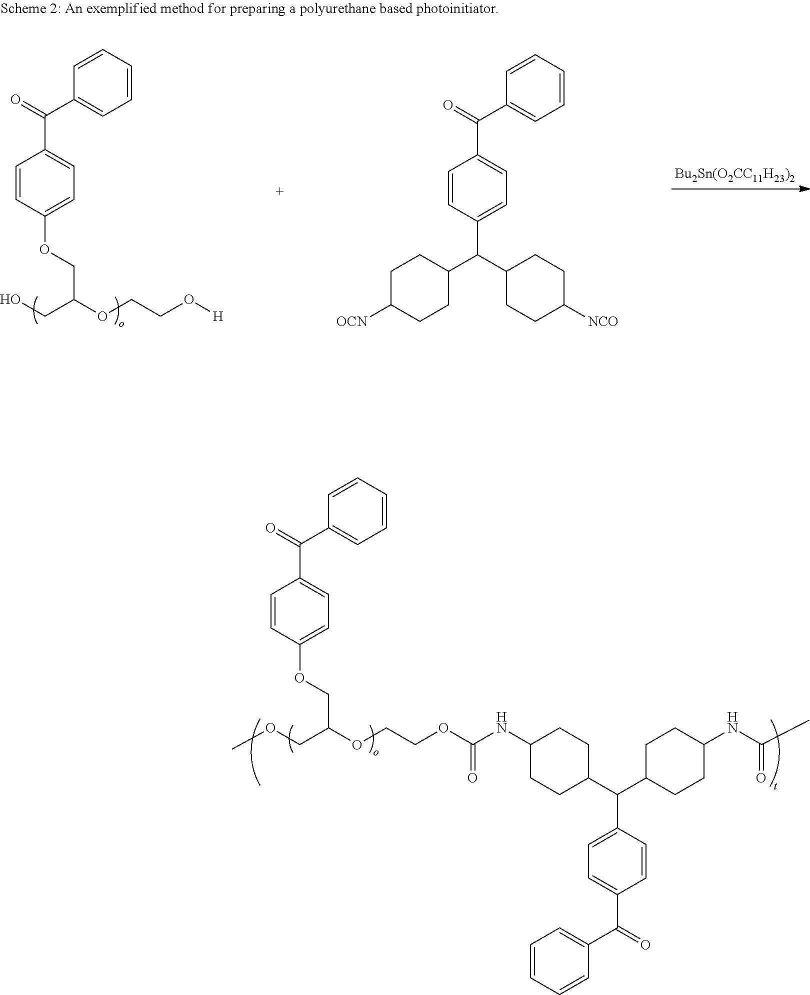

The isocyanate depicted in Scheme 2 is (4-(bis-(4-isocyanatocyclohexyl)methyl)phenyl)(phenyl)methanone. Various other isocyanates may be used including α,ω-alkylene diisocyanates having from 5 to 20 carbon atoms such as photoinitiator substituted tetramethylene diisocyanate, hexamethylene diisocyanate, trimethylhexamethylene diisocyanate, isophorone diisocyanate, diethylbenzene diisocyanate, decamethylene 1,10-diisocyanate, cyclohexylene 1,2-diisocyanate and cyclohexylene 1,4-diisocyanate, 1,12-dodecane diisocyanate, 2-methyl-1,5-pentamethylene and the aromatic isocyanates such as 2,4- and 2,6-tolylene diisocyanate, 4,4-diphenylmethane diisocyanate, 1,5-naphthalene diisocyanate, dianisidine diisocyanate, tolidine diisocyanate, bis(4-isocyanatocyclohexyl)methane also polymeric types of polyisocyanate such as neopentyl tetra isocyanate, m-xylylene diisocyanate, tetrahydronaphthalene-1,5 diisocyanate, and bis(4-isocyanatophenyl)methane.

The end-groups present on the polyurethane based photoinitiator are dependent on the stoichiometry of the reactants. If for example, the end-groups of the polymer are supposed to be free hydroxy groups, an excess of the polyalkylether reactant should be used in comparison with the amount of the isocyanate. On the other hand, if free isocyanate groups should be present as end-groups an excess of the isocyanate should be used.

It can also be envisioned that more than one polyalkylether photoinitiator moiety is used as reactant.

Other polyurethane based photoinitiators are reported in the literature, such as the benzophenone derivatized polyurethanes in J. Wei, H. Wang, X. Jiang, J. Yin, Macromolecules, 40 (2007), 2344-2351): An example of such photoinitiators is presented in Scheme 3.

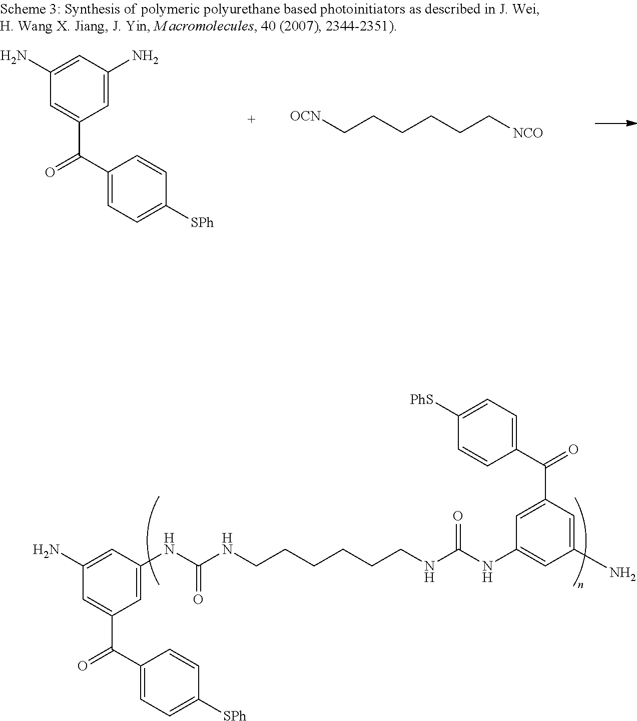

One particular attractive property of coating compositions consisting solely of polyurethane derived photoinitiators is the additional physical cross-linking induced by the urethane segments as compared to for example a polymeric photoinitator with no possibility for hydrogen bonding. This additional physical cross-linking should render the polyalkyletherurethane based photoinitiators more efficient in producing for example hydrogels in comparison to a polyalkylether based photoinitiator, and should render them thermoplastic.

An example of a polyurethane based photoinitiator possessing the properties described above is depicted in Scheme 4.

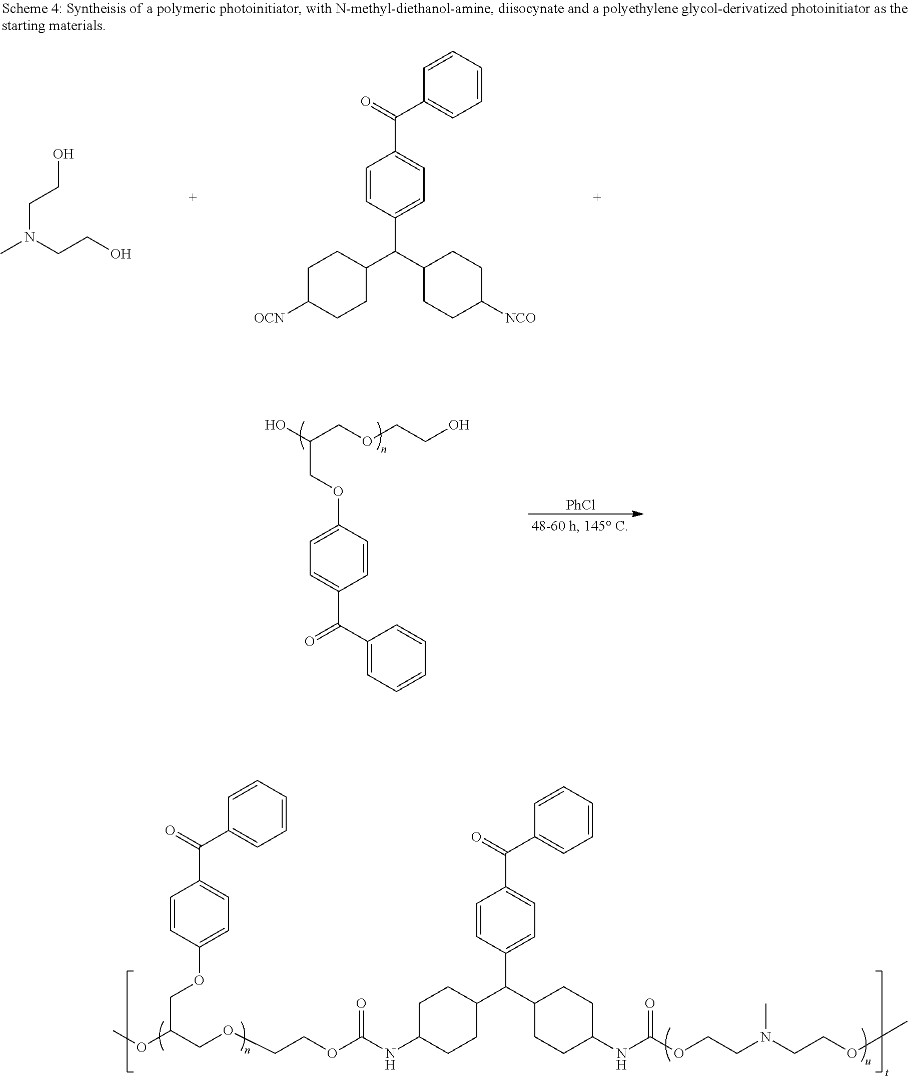

Utilizing the sum-formula,

(—(R₁(A₁)ₘ)ᵤ-(R₂(A₂)ₙ-O)ₒ—(R₃(A₃)ₚ-O)_{q}—(R₄(A₄)ᵣ)ᵥ-C(O)NH—R₅(A₅)ₛ-NHC(O))ₜ—,

the polymer shown in Scheme 4 can be written as,

(—OCH₂CH₂N(CH₃)CH₂CH₂O)ᵤ—(OCH(CH₂OPhCOAr)₁CH₂O)ₙ—C(O)NH—C₆H₁₀CH(PhCOPh)C₆H₁₀NHC(O)—)ₜ

This example represents a general method of incorporating photoinitiators substituted with diethanolamine into a polyurethane.

Several other methods exist for the synthesis of the polyurethane based photoinitiators, with some of the important methods outlined below:

Initially, an isocyanate-terminated prepolymer is formed by reacting a photoinitiator polyalkylether with an isocyanate and possibly one or more chain extender(s). Such prepolymers are characterized by having isocyanate groups and/or alcohol, amine or other nucleophilic functionalities as end-groups in the polymer. Furthermore, the prepolymer has a lower molecular weight than the targeted polyurethane photoinitiator. The prepolymers can be formed without the use of a catalyst, however, a catalyst chosen from the catalyst described above, can be preferred in some instances. In instances, where the prepolymer has pendent carboxyl groups, an optional neutralization of the prepolymer will result in carboxylate anions, thus having an increased solubility or dispersibility in water. Suitable neutralizing agents include tertiary amines, metal hydroxides, ammonium hydroxide, phosphines, and other agents well known to those skilled in the art. Tertiary amines and ammonium hydroxide are preferred, such as triethyl amine, dimethyl ethanolamine, N-morpholine, and the like, and mixtures thereof. It is recognized that primary or secondary amines may be used in place of tertiary amines, if they are sufficiently hindered to avoid interfering with the chain extension process. The pre-polymer can then be processed to form the polyurethane photoinitiators described in the present invention by

(1) Dispersion of the prepolymer by shear forces with emulsifiers (external emulsifiers, such as surfactants or internal emulsifiers, having anionic and/or cationic groups as part of or pendant to the polyurethane backbone, and/or as end groups on the polyurethane backbone).

(2) Acetone process, where a prepolymer is formed with or without the presence of acetone, methylethylketone, and/or other polar solvents that are non-reactive and easily distilled. If necessary, the prepolymer is further diluted in the before mentioned solvents and chain extended with chain extenders mentioned previously. Water is added to the chain-extended polyurethane and the solvents are distilled off. A variation on this process would be to chain extend the prepolymer after its dispersion into water.

(3) Melt dispersion process, where an isocyanate-terminated prepolymer is formed, and then reacted with an excess of ammonia or urea to form a low molecular weight oligomer having terminal urea or biuret groups. This oligomer is dispersed in water and chain extended by methylolation of the biuret groups with formaldehyde.

(4) Ketazine and ketimine processes, hydrazines or diamines are reacted with ketones to form ketazines or ketimines. These are added to a prepolymer and remain inert to the isocyanate. As the prepolymer is dispersed in water, the hydrazine or diamine is liberated, and chain extension takes place as the dispersion is taking place.

(5) Continuous process polymerization, where an isocyanate-terminated prepolymer is formed. This prepolymer is pumped through high shear mixing head(s) and dispersed into water and then chain extended at said mixing head(s), or dispersed and chain extended simultaneously at the before mentioned mixing head(s). This is accomplished by multiple streams consisting of prepolymer (or neutralized prepolymer), optional neutralizing agent, water, and optional chain extender and/or surfactant.

(6) Reverse feed process, where water and optional neutralizing agent(s) and/or extender amine(s) are charged to the prepolymer under agitation. The prepolymer can be neutralized before water and/or diamine chain extenders are added.

(7) Solution polymerisation.

(8) Bulk polymerisation, including but not limited to extrusion processes.

In the present invention, M_{w} (the weight averaged molecular weight) is used to characterize the polymeric photoinitiators. Efficiency of the polymeric photoinitiator is related to how well the photoinitiator is blended with the gel-forming polymer(s) or monomer(s). Amongst important parameters in this respect is the molecular weight of the photoinitiator. A molecular weight which is too high does not allow for good miscibility of the polymeric photoinitiator with other components of the matrix composition. In particular, if the chemical nature and molecular weight of the polymeric photoinitiator and the gel-forming polymer(s) are markedly different, a poor miscibility is obtained, which in turn results in a matrix composition that is difficult to cure.

In one embodiment, therefore, the photoinitiator according to the invention suitably has a weight averaged molecular weight between 0.2 kDa and 100 kDa, more preferably between 0.2 kDa and 75 kDa, preferably between 0.5 and 50 kDa. Suitably, the weight averaged molecular weight of the photoinitiator is 0.5-40 kDa and the loading of benzophenone moiety is greater than 0% and below 50%.

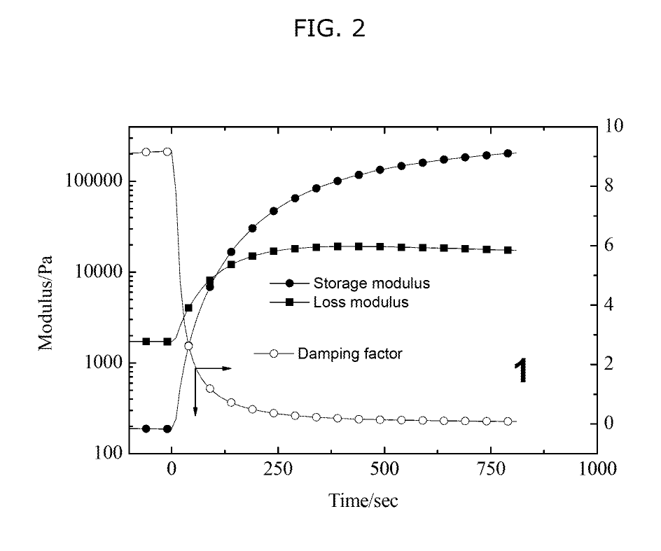

Example 2 is an example of curing of a polyurethane (obtained from example 1) for the purpose of creating a hydrogel. The cured sample (see FIG. 2) is a hydrogel precursor, which means that a hydrogel is obtained by exposing the cured sample to water or aqueous swelling media. The molecular weight of the polymer from example 1 is 43 kDa.

Curing

The matrix composition of the invention is cured by exposing it to UV radiation.

Curing can either occur in the molten state, or in a solution. The latter comprises steps, where the matrix composition is dissolved in a suitable solvent and for example spray-coated on to a tube, and subsequently exposed to UV radiation. The solvent can afterwards either be evaporated or remain in the coating and function as a swelling medium to provide the desired gel.

The ultraviolet spectrum is divided into A, B and C segments where UV A extends from 400 nm to 315 nm, UV B from 315 to 280 nm, and UV C from 280 to 100 nm. By using a light source that generates light with wavelengths in the visible region (400 to 800 nm), some advantages are obtained with respect to the depth of the curing, provided that the photoinitiator can successfully cure the material at these wavelengths. In particular, scattering phenomena are less pronounced at longer wavelength, thus giving a larger penetration depth in the material. Thus, photoinitiators which absorb, and can induce curing at longer wavelength, are of interest. By judicially choosing substituents on the aromatic moieties, the absorption spectrum of the polymeric photoinitiator can to some extent be red-shifted, which would then facilitate curing at comparatively greater depths.

Multi-photon absorption can also be used to cure samples using light sources emitting at wavelengths twice or even multiple times the wavelength of light needed for curing in a one-photon process. For example, a composition containing a photoinitiator with an absorption maximum at ˜250 nm could possibly be cured with a light source emitting at ˜500 nm utilizing a two-photon absorption process, provided that the two-absorption cross section is sufficiently high. A multi-photon initiated cure process could also facilitate greater spatial resolution with respect to the cured area (exemplified in Nature 412 (2001), 697 where a 3D structure is formed by a two-photon curing process).

In the present invention, curing is primarily initiated by exposing the matrix composition to high energy irradiation, preferably UV light. The photoinitiated process takes place by methods described above and which are known per se, through irradiation with light or UV irradiation in the wavelength range from 250 to 500 nm. Irradiation sources which may be used are sunlight or artificial lamps or lasers. Mercury high-pressure, medium pressure or low-pressure lamps and xenon and tungsten lamps, for example, are advantageous. Similarly, excimer, solid state and diode based lasers are advantageous. Even pulsed laser systems can be considered applicable for the present invention. Diode based light sources in general are advantageous for initiating the chemical reactions.

In the curing process the polymeric photoinitiator transforms the matrix composition in a chemical process induced by light.

Auto-Curing

The polymeric photoinitiators described here can both facilitate curing of a surrounding matrix, but since the photoinitiators themselves are polymers they can also “auto-cure”, meaning that the polymeric photoinitiators can solely constitute the matrix composition that is cured with UV irradiation. This is particularly relevant when at least one of A₁, A₂, A₃, A₄ and A₅ is an optionally-substituted benzophenone moiety.

In one aspect, therefore, the invention provides a method for the manufacture of a cross-linked matrix composition, said method comprising the steps of
a. providing a matrix composition consisting of a polymeric photoinitiator of the general formula I:

(—(R₁(A₁)ₘ)ᵤ-(R₂(A₂)ₙ-O)ₒ—(R₃(A₃)ₚ-O)_{q}—(R₄(A₄)ᵣ)ᵥ-C(O)NH—R₅(A₅)ₛ—NHC(O))ₜ— (I)
wherein R₂, R₃ and R₅ can each independently be selected from C1-C25 linear alkyl, C3-C25 branched alkyl, C3-C25 cycloalkyl, aryl and heteroaryl groups such as any aromatic hydrocarbon with up to 20 carbon atoms;
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, hydrazine, azines, hydrazides, polyethylenes, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁-C₈ straight chain alkyl group, C₃-C₈ branched or cyclic alkyl group;
m, n, p, r and s are real numbers, from 0 to 10, provided that the sum of n+p+s is a real number greater than 0;
o and q are real numbers from 0 to 10000;
u and v are real numbers from 0 to 1;
t is an integer from 1 to 10000; and
A₁, A₂, A₃, A₄ and A₅ are identical or different photoinitiator moieties, and
b. curing the matrix composition obtained in step a. by exposing it to UV radiation.

The present invention provides a cross-linked matrix composition obtainable via the above method.

The “auto-curing” method suitably takes place with steps a. and b. occurring directly after one another (i.e. with no intermediate steps). In one aspect of this “auto-curing” method, the method consists of steps a. and b. alone.

A one-component system—as provided by the “auto-curing” method—provides advantages, in that the polymeric photoinitiators are thermoplastic. As such, they become less viscous under higher shear rate, making them easier to process in an extrusion process. In contrast, for example, polyvinyl pyrrolidone cannot be extruded. All details and structural refinements of the polymeric photoinitiator provided herein are aimed at providing photoinitiators suitable for use in the “auto-curing” method.

In addition, the polymeric photoinitiators of the “auto-curing” method may comprise the sole component of the matrix composition; i.e. the matrix composition may consist of the polymeric photoinitiators. This provides the advantage that additives (e.g. plasticizers, viscosity modifiers) can be avoided, thereby reducing the chances of low molecular weight components from leaching from the cross-linked matrix composition.

Gel-State

A gel is characterized as a swellable material, however, insoluble in the swelling medium. By hydrogel is meant a material comprised mainly of a water soluble or water swellable material. The gel material is characterized in terms of its rheological properties and in its dry state. In particular, the storage and the loss modulus are used to characterize the mechanical properties of the materials (T. G. Mezger: “The Rheology Handbook”, Vincentz Network, Hannover, 2006). As described above, curing of a matrix composition is followed by monitoring the change of G′(ω) and G″(ω) as a function of UV exposure time. In the examples used to describe the present invention, a frequency of 1 Hz is used to probe the rheological properties and further, the samples were heated to 120° C. during testing.

The invention also relates to a gel, obtainable via the methods described herein.

### EXAMPLE 1

A 50 mL two-neck flask was charged with (4-((bis(2-hydroxyethyl)amino)methyl)phenyl)(phenyl)methanone (0.04 g, 0.13 mmol) and PEG2000 (1.7 g, 0.85 mmol). Moisture was removed from the reaction flask by melting the reactants under vacuum and heating the liquid reaction mixture until all effervescence ceased (approx. 5 min at 80 ° C.). The flask was allowed to cool under vacuum, fitted with a reflux condenser and flushed with nitrogen. Dry chlorobenzene (10 mL) was added and the reaction mixture was stirred at 60 ° C. to obtain a homogeneous clear solution. 4,4′-methylenebis(cyclohexyl-isocyanate) (0.26 g, 0.99 mmol) was added via syringe and the reaction mixture was heated under reflux for 48-60 h to 145° C. The viscous yellow mixture was cooled to ambient temperature, diluted in toluene (50 mL) and evaporated to dryness. Methanol (125 mL) and water (75 mL) were added to the residue to provide a viscous turbid solution. Evaporation of the mixture gave a gummy solid that was dried in vacuo for 4-6 h at 75 ° C., leaving a pale yellow solid in nearly quantatively yield (1). M_{w} 43 kDa, PD=2.4.

### EXAMPLE 2

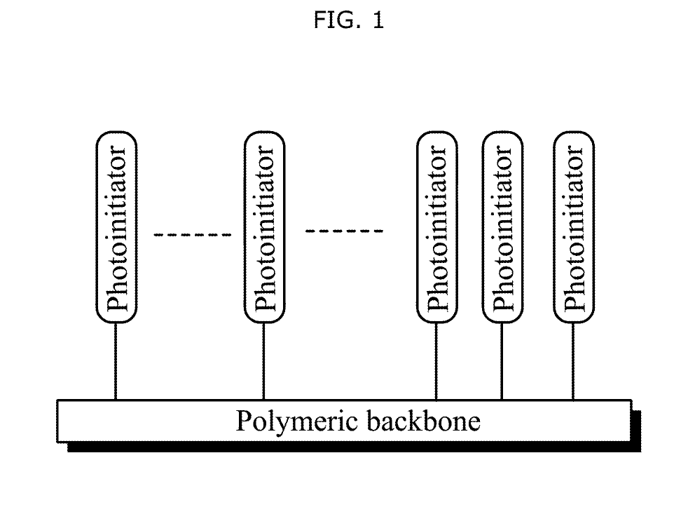

An oblate of the pristine polymer from example 1 was placed between the two plates in a rheometer (parallel plate configuration, bottom plate is a quartz glass plate) and the distance between the plates was set to 0.3 mm and the temperature to 120 ° C. The measurements were run with fixed strain of 1% and a constant frequency of 1 Hz. When the loss and storage modules had stabilized, a UV-lamp was turned on, thus irradiating the sample through the bottom plate on the rheometer via a fiber from the lamp. The loss and storage modules were then followed as a function of time, while the UV-lamp was irradiating the sample. Illustrative results of the measurements are shown in FIG. 1. The sample increases its solid content when exposed to UV which is seen from the decrease in tan δ. An increase in tan δ signifies an increasing amount of liquid present in the sample.

1. A polymeric photoinitiator of the general formula I:
(—(R₁ (A₁)ₘ)ᵤ-(R₂(A₂)ₙ-O)ₒ—(R₃(A₃)ₚ-O)_{q}—(R₄(A₄)ᵣ)ᵥ-C(O)NH—R₅ (A₅)ₛ-NHC(O))ₜ— (I)
wherein R₂, R₃ and R₅ can each independently be selected from C1-C25 linear alkyl, C3-C25 branched alkyl, C3-C25 cycloalkyl, aryl and heteroaryl groups such as any aromatic hydrocarbon with up to 20 carbon atoms;
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, nitrates, acrylates, hydrazine, azines, hydrazides, polyethylenes, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters;
ethers; amides; halogen atoms; sulfones; sulfonic derivatives; NH₂ or Nalk₂, where alk is any C₁-C₈ straight chain alkyl group, C₃-C₈ branched or cyclic alkyl group;
m, n, p, and r are independently real numbers from 0 to 10 and s is a real number greater than or equal to 1;
o and q are independently real numbers from 0 to 10000, provided that both o and q are not zero;
u and v are independently real numbers from 0 to 1;
t is an integer from 1 to 10000; and
A₁, A₂, A₃, A₄ and A₅ are identical or different photoinitiator moieties.

2. The polymeric photoinitiator according to claim 1, wherein R₁ and R₄ are end-functionalized with alcohol, ether, urethane or amine groups, alternatively other nucleophilic groups, in either one or both ends.

3. The polymeric photoinitiator according to claim 1, wherein R₁ and R₄ are selected from the group consisting of ethylene diamine, diethylene triamine, triethylene tetramine, propylene diamine, butylenes diamine, hexamethylene diamine, cyclohexylene diamine, piperazine, 2-methyl-piperazine, phenylene diamine, tolylene diamine, xylylene diamine, tris(2-aminoethyl) amine, 3,3′-dinitrobenzidine, 4,4′-methylenebis (2-chloroaniline), 3,3′-dichloro-4,4′-bi-phenyl diamine, 2,6-diaminopyridine, 4,4′-diaminodiphenylmethane, menthane diamine, m-xylene diamine and isophorone diamine.

4. The polymeric photoinitiator according to claim 1, wherein R₁ and R₄ are selected from the group consisting of hydrazine; azines such as acetone azine; substituted hydrazines such as dimethyl hydrazine, 1,6-hexamethylene-bishydrazine, and carbodihydrazine; hydrazides of dicarboxylic acids and sulfonic acids such as adipic acid mono- or dihydrazide, oxalic acid dihydrazide, isophthalic acid, dihydrazide, tartaric acid dihydrazide, 1,3-phenylene disulfonic acid dihydrazide, omega-amino-caproic acid dihydrazide; hydrazides made by reacting lactones with hydrazine such as gamma-hydroxylbutyric hydrazide, bis-semi-carbazide and bis-hydrazide carbonic esters of glycols.

5. The polymeric photoinitiator according to claim 1, wherein R₁ and R₄ are each independently selected from C1-C25 linear alkyl, C3-C25 branched alkyl and C3-C25 cycloalkyl.

6. The polymeric photoinitiator according to claim 1, wherein R₅ is selected from the group consisting of C3-C25 cycloalkyl and aryl groups.

7. The polymeric photoinitiator according to claim 1, wherein R₂ and R₃ are each independently selected from C1-C25 linear alkyl, C3-C25 branched alkyl and C3-C25 cycloalkyl, preferably C1-C25 linear alkyl.

8. The polymeric photoinitiator according to claim 1, wherein at least one of A₁, A₂, A₃, A₄ and A₅ is an optionally substituted benzophenone moiety.

9. The polymeric photoinitiator according to claim 1, wherein A₁, A₂, A₃, A₄ and A₅ are selected from the group consisting of benzoin ethers, phenyl hydroxyalkyl ketones, phenyl aminoalkyl ketones, benzophenones, thioxanthones, xanthones, acridones, anthraquinones, fluorenones, dibenzosuberones, benzils, benzil ketals, □-dialkoxy-acetophenones, □-hydroxy-alkyl-phenones, □-amino-alkyl-phenones, acyl-phosphine oxides, phenyl ketocoumarins, silane, maleimides, and derivatives thereof.

10. The polymeric photoinitiator according to claim 1, wherein A₁, A₂, A₃, A₄ and A₅ are selected from the group consisting of benzoin ethers, phenyl hydroxyalkyl ketones, phenyl aminoalkyl ketones, benzophenones, thioxanthones, xanthones and derivatives thereof.

11. The polymeric photoinitiator according to claim 1, wherein the weight averaged molecular weight of the polymeric photoinitiator is between 0.2 kDa and 100 kDa, preferably between 0.2 kDa and 75 kDa, more preferably between 0.5 and 50 kDa.

12. The polymeric photoinitiator according to claim 1, wherein the weight averaged molecular weight of the polymeric photoinitiator is 0.5-40 kDa and the loading of benzophenone moiety is greater than 0% and below 50%.

13. The polymeric photoinitiator according to claim 1, wherein o and q are independently real numbers from 1-5000, preferably 100-2000.

14. The polymeric photoinitiator according to claim 1, wherein t is an integer from 1 to 5000, preferably 100-2000.

15. The polymeric photoinitiator according to claim 1, wherein the sum m+n+p+r+s is 1.

16. The polymeric photoinitiator according to claim 1, wherein s is greater than 1.

17. The polymeric photoinitiator according to claim 1, wherein both r and v are greater than 0.

18. The polymeric photoinitiator according to claim 1, wherein r is zero.

19. The polymeric photoinitiator according to claim 1, wherein m is zero.

20. The polymeric photoinitiator according to claim 1, wherein both p and q are greater than 0.

21. A method for the manufacture of a cross-linked matrix composition, said method comprising the steps of
a. providing a matrix composition consisting of a polymeric photoinitiator of the general formula I:
(—(R₁(A₁)ₘ)ᵤ-(R₂(A₂)ₙ-O)ₒ-(R₃(A₃)ₚ-O)_{q}—(R₄(A₄)ᵣ)ᵥ-C (O)NH—R₅(A₅)ₛ-NHC(O)ₜ— (I)
wherein R₂, R₃ and R₅ can each independently be selected from C1-C25 linear alkyl, C3-C25 branched alkyl, C3-C25 cycloalkyl, aryl and heteroaryl groups such as any aromatic hydrocarbon with up to 20 carbon atoms;
R₁ and R₄ are each independently selected from C1-C25 linear alkyl, C3-C25 branched alkyl, C3-C25 cycloalkyl, aryl, heteroaryl, hydrogen, —OH, —CN, halogens, amines, amides, alcohols, ethers, thioethers, sulfones and derivatives thereof, sulfonic acid and derivatives thereof, sulfoxides and derivatives thereof, carbonates, isocyanates, nitrates, acrylates, hydrazine, azines, hydrazides, polyethylenes, polypropylenes, polyesters, polyamides, polyacrylates, polystyrenes, and polyurethanes; and when R₁ and R₄ are alkyl and aryl groups, they may be substituted with one or more substituents selected from CN; OH; azides; esters; ethers; amides; halogen atoms; sulfones; sulfonic derivatives; NH₂ or Nalk₂, where alk is any C₁-C₈ straight chain alkyl group, C₃-C₈ branched or cyclic alkyl group;
m, n, p, r and s are real numbers, from 0 to 10, provided that the sum of n+p+s is a real number greater than 0;
o and q are real numbers from 0 to 10000;
u and v are real numbers from 0 to 1;
t is an integer from 1 to 10000; and
A₁, A₂, A₃, A₄ and A₅ are identical or different photoinitiator moieties, and
b. curing the matrix composition obtained in step a. by exposing it to UV radiation.

22. A cross-linked matrix composition obtainable via the method of claim 21.

23. The use of a polymeric photoinitiator according to claim 1 for curing a matrix composition.
